(19) United States
(12) Patent Application Publication
(10) Pub. No.: US 2011/0080087 A1
(43) Pub. Date: Apr. 7, 2011

(54) ORGANIC ELECTRO-LUMINESCENT DEVICE PACKAGE AND PACKAGING PROCESS THEREOF

(75) Inventor: Chin-Yu Chang, Nantou County (TW)

(73) Assignee: AU OPTRONICS CORPORATION, Hsinchu (TW)

(21) Appl. No.: 12/626,947

(22) Filed: Nov. 30, 2009

(30) Foreign Application Priority Data
Oct. 7, 2009 (TW) 98133993

(51) Int. Cl. H01J 1/62; H01J 9/26

(52) U.S. Cl. 313/504; 445/25

(57) ABSTRACT

An organic electro-luminescent device (OELD) package including a substrate, a plurality of OELDs, a transparent cover, a plurality of sealants, and a plurality of optical fills is provided. The OELDs are disposed on the substrate. The transparent cover is disposed above the substrate to cover the OELDs. Here, the transparent cover has a plurality of fillisters located above the OELDs to accommodate the OELDs, respectively. The sealants are disposed between the substrate and the transparent cover. Each of the sealants surrounds one of the OELDs, respectively. Each of the optical fills respectively fills one of the fillisters and a space surrounded by one corresponding sealant and encapsulates one of the OELDs. Additionally, a packaging process of OELDs is also provided.

### CROSS-REFERENCE TO RELATED APPLICATION

This application claims the priority benefit of Taiwan application serial no. 98133993, filed on Oct. 7, 2009. The entirety of the above-mentioned patent application is hereby incorporated by reference herein and made a part of specification.

### BACKGROUND OF THE INVENTION

1. Field of the Invention

The application relates to an organic electro-luminescent device (OELD) package and a packaging process thereof. More particularly, the application relates to an OELD package suitable for mass production and a packaging process of the OELD package.

2. Description of Related Art

With great advance of electronic products and increasing demands for portable electronic products, displays on the electronic products featuring satisfactory response speed, resolution, and image quality have drawn more attention. The electronic products are developed to have not only multiple functions but also compactness. Since OELD displays are self-emissive displays in no need of additional backlight modules, the OELD displays sufficiently comply with the requirement of compactness for the electronic products.

In general, the OELD displays can be classified into bottom emission OELD displays and top emission OELD displays. The most common bottom emission OELD displays frequently employ ultraviolet (UV) sealants and desiccating agents to prevent moisture from entering the package of the OELD display. Nevertheless, light emitting directions of the bottom emission OELD displays and those of the top emission OELD displays are different, and therefore the desiccating agents capable of shielding light cannot be used in a packaging process of the top emission OELD displays. At present, the top emission OELD displays often adopt the laser frit technology together with the dam and fill technology. However, said two technologies frequently used to package the top emission OELD displays require high costs and high process accuracy.

### SUMMARY OF THE INVENTION

To effectively reduce manufacturing costs and simplify fabrication, the application is directed to an OELD package and a packaging process thereof.

In the application, an OELD package including a substrate, a plurality of OELDs, a transparent cover, a plurality of sealants, and a plurality of optical fills is provided. The OELDs are disposed on the substrate. The transparent cover is disposed above the substrate to cover the OELDs. Here, the transparent cover has a plurality of Misters located above the OELDs to accommodate the OELDs, respectively. The sealants are disposed between the substrate and the transparent cover. Each of the sealants surrounds one of the OELDs, respectively. Each of the optical fills respectively fills one of the fillisters and a space surrounded by one corresponding sealant and encapsulates one of the OELDs.

According to an exemplary embodiment of the invention, each of the OELDs includes a first electrode layer, an organic electro-luminescent layer, and a second electrode layer. The first electrode layer is disposed on the substrate, the organic electro-luminescent layer is disposed on the first electrode layer, and the second electrode layer is disposed on the organic electro-luminescent layer.

According to an exemplary embodiment of the invention, the first electrode layer is a reflective electrode layer, and the second electrode layer is a transmissive or a semi-transparent electrode layer. In other words, the OELDs are top emission OELDs. According to an exemplary embodiment of the invention, a thickness of each of the OELDs is T1, a thickness of each of the sealants is T2, and T1<T2 or T1<T2+D.

In the application, a packaging process of OELDs is also provided. First, a transparent cover having a plurality of fillisters is provided. Next, each of the fillisters is filled with a liquid optical fill, and a plurality of sealants are formed on the transparent cover. Here, each of the sealants surrounds one of the fillisters. After that, the transparent cover is bonded to the substrate by the sealants, such that the OELDs are immersed in the liquid optical fills. Here, the substrate has the OELDs thereon. The sealants and the liquid optical fills are then cured.

According to an exemplary embodiment of the invention, each of the fillisters is filled with the liquid optical fill by blade coating or screen printing.

According to an exemplary embodiment of the invention, a method of curing the sealants and the liquid optical fills includes UV curing or thermal curing.

Based on the above, the fillisters of the transparent cover are filled with the optical fills according to the invention, so as to package the OELDs at the same time. Therefore, the invention is conducive to mass production of the OELDs.

In order to make the aforementioned and other features and advantages of the invention more comprehensible, embodiments accompanied with figures are described in detail below.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention.

FIGS. 1A˜1D are schematic cross-sectional views of an OELD according to an embodiment of the invention.

FIGS. 2A˜2D are schematic top views of an OELD according to an embodiment of the invention.

### DESCRIPTION OF EMBODIMENTS

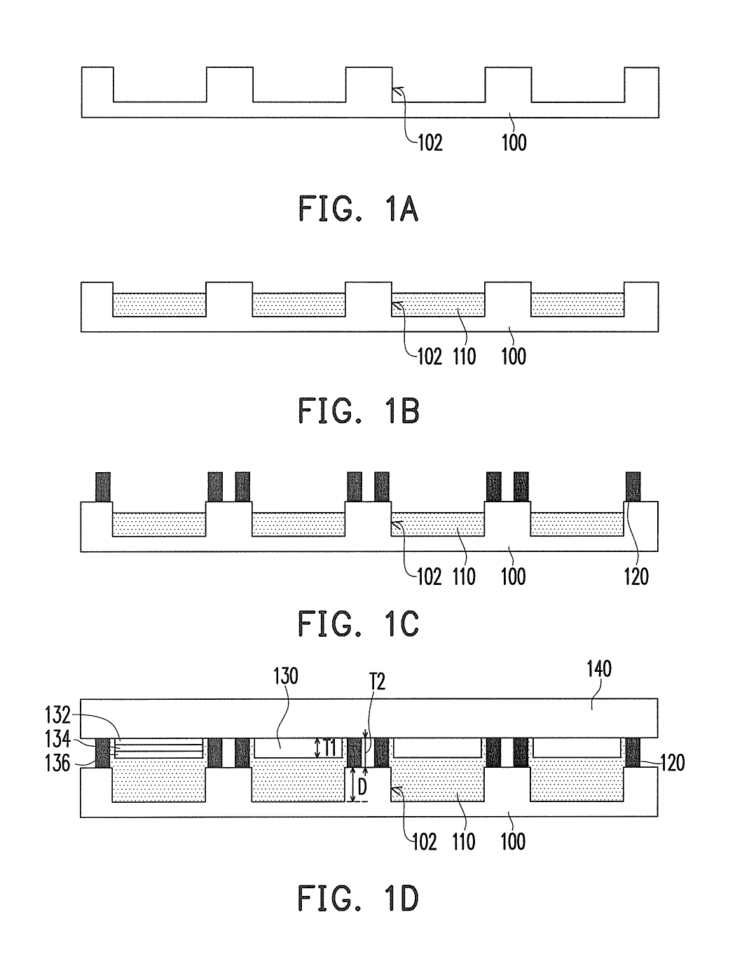

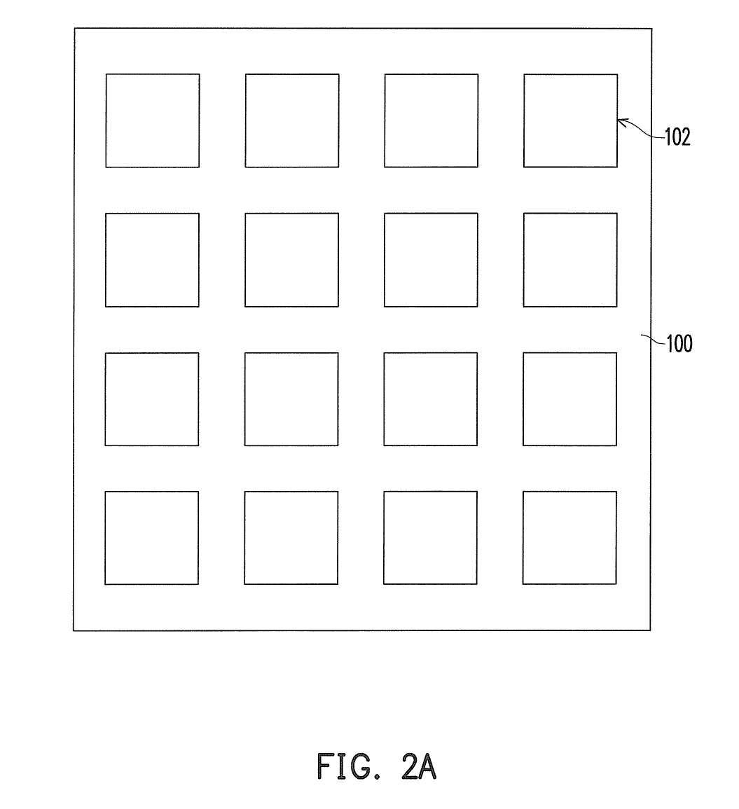

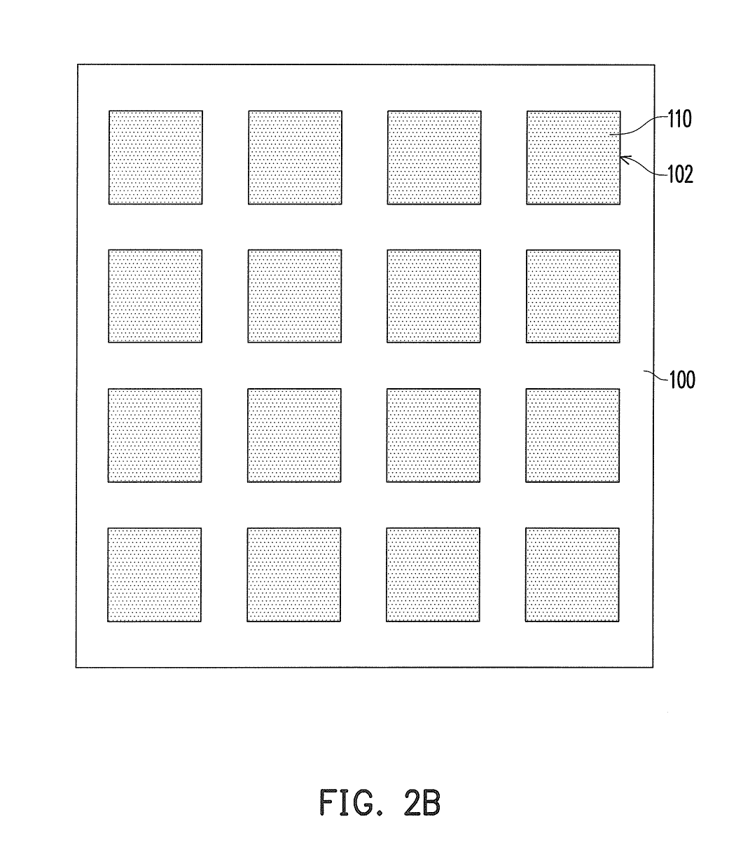

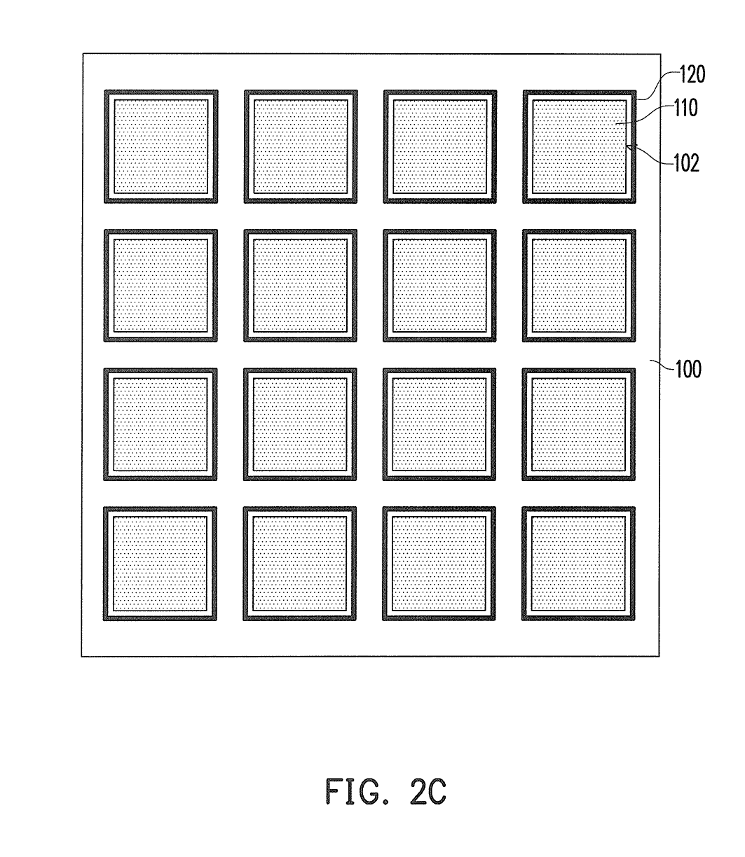

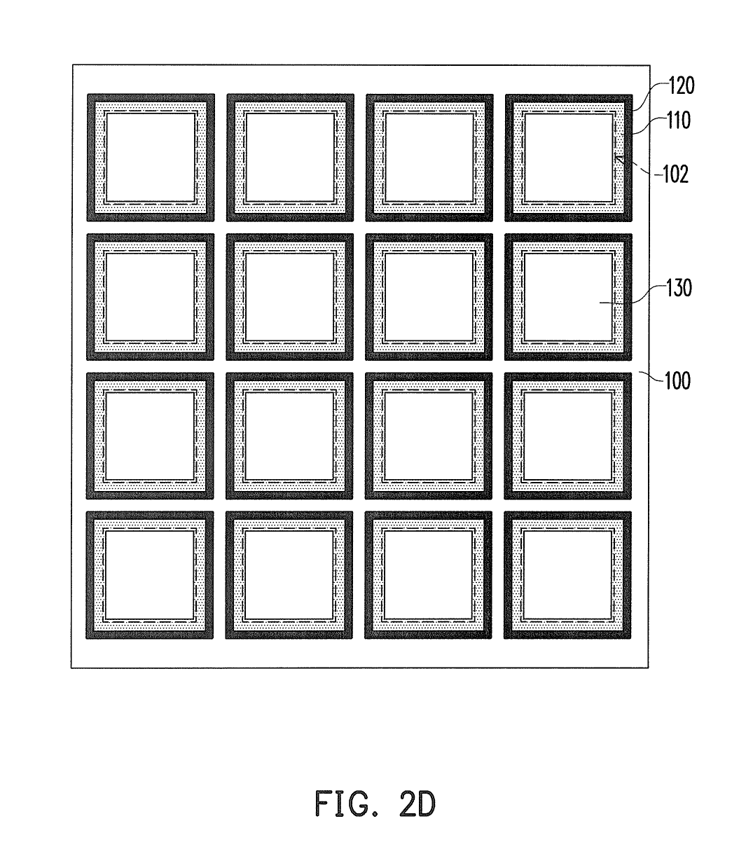

FIGS. 1A˜1D are schematic cross-sectional views of an OELD according to an embodiment of the invention. FIGS. 2A˜2D are schematic top views of an OELD according to an embodiment of the invention. First, as indicated in FIGS. 1A and 2A, a transparent cover 100 is provided. Here, the transparent cover 100 has a plurality of fillisters 102. In the embodiment, the transparent cover 100 is, for example, a glass substrate, a plastic substrate, or a substrate made of other materials. The fillisters 102 are formed by, for example, etching, thermal compression, polishing, and so on. Specifically, in the embodiment, transparent parent materials (not shown) with the same thickness can be partially removed by etching, thermal compression, polishing, and so forth, such that different portions of the transparent parent materials can have different thicknesses. Here, the portions with smaller thicknesses are the fillisters 102, while the other portions with greater thicknesses are side walls of the fillisters 102. Shapes and depths of the fillisters 102 are relevant to shapes and thicknesses of the OELDs, and people having ordinary skills in the art are able to adjust the shapes and the depths of the fillisters 102 based on configurations of the OELDs.

It can be learned from FIG. 1B that the fillisters 102 of the embodiment are rectangular fillisters, for instance. Besides, the rectangular fillisters are arranged in array on a surface of the transparent cover 100. In other embodiments, the fillisters 102 can have a rhombus shape, a hexagonal shape, a circular shape, or other appropriate shapes. Additionally, the fillisters 102 can have a mosaic type arrangement, a delta type arrangement, a stagger type arrangement, or any other proper arrangement.

Next, as shown in FIGS. 1B and 2B, each of the fillisters 102 is filled with a liquid optical fill 110. In the embodiment, each of the fillisters 102 can be filled with the corresponding liquid optical fill 110 by blade coating, screen printing or nozzle dispensing. Here, the liquid optical fill 110 is, for example, UV curable or thermal curable. Preferably, the liquid optical fill 110 has a favorable light transmission rate.

Thereafter, in FIGS. 1C and 2C, a plurality of sealants 120 are formed on the transparent cover 100, and each of the sealants 120 surrounds one of the fillisters 102, respectively. In the embodiment, the sealants 120 are, for example, UV curable or thermal curable.

As shown in FIGS. 1D and 2D, a substrate 140 on which the OELDs 130 are formed is then provided, and the substrate 140 and the transparent cover 100 are bonded by the sealants 120, such that the OELDs 130 are immersed in the liquid optical fills 110. According to the embodiment, the substrate 140 on which the OELDs 130 are formed is, for example, an active matrix organic electro-luminescent display (AMOELD) panel or a passive matrix organic electro-luminescent display (PMOELD) panel.

In the embodiment, the amount of the liquid optical fill 110 which fills each of the fillisters 102 can be calculated in advance, such that each of the fillisters 102 and a space surrounded by the corresponding sealant 120 can be completely filled with the liquid optical fill 110.

After the substrate 140 and the transparent cover 100 are bonded together, the sealants 120 and the liquid optical fills 110 are cured. According to the embodiment, the sealants 120 and the liquid optical fills 110 can be simultaneously or separately cured. Particularly, in the embodiment, the sealants 120 and the liquid optical fills 110 can be simultaneously cured by thermal curing or UV curing. Certainly, the liquid optical fills 110 can also be cured before the sealants 120 are cured according to the embodiment. In an alternative, the sealants 120 are cured before the liquid optical fills 110 are cured.

It can be learned from FIGS. 1D and 2D that the OELD package of the embodiment includes a substrate 140, a plurality of OELDs 130, a transparent cover 100, a plurality of sealants 120, and a plurality of optical fills 110. The OELDs 130 are disposed on the substrate 140. The transparent cover 100 is disposed above the substrate 140 to cover the OELDs 130. Here, the transparent cover 100 has a plurality of fillisters 102 corresponding to the OELDs 130 to accommodate the OELDs 130, respectively. The sealants 120 are disposed between the substrate 140 and the transparent cover 100. Each of the sealants 120 surrounds one of the OELDs 130, respectively. Each of the optical fills 110 respectively fills one of the fillisters 102 and a space surrounded by one corresponding sealant 120 and encapsulates one of the OELDs 130.

In the embodiment, each of the OELDs 130 includes a first electrode layer 132, an organic electro-luminescent layer 134, and a second electrode layer 136. Here, the first electrode layer 132 is disposed on the substrate 140, the organic electro-luminescent layer 134 is disposed on the first electrode layer 132, and the second electrode layer 136 is disposed on the organic electrode-luminescent layer 134. According to an exemplary embodiment of the invention, the first electrode layer 132 is a reflective electrode layer, and the second electrode layer 136 is a transmissive or a semi-transparent electrode layer. In other words, the OELDs 130 are top emission OELDs. Undoubtedly, given that the OELDs 130 are bottom emission OELDs, the first electrode layer 132 is a transmissive or a semi-transparent electrode layer, and the second electrode layer 136 is a reflective electrode layer.

It can be learned from FIG. 1D that a thickness of each of the OELDs 130 is T1, a thickness of each of the sealants 120 is T2, a depth of each of the fillisters 102 is D, and T1<T2. However, T1 is not limited to be smaller than T2, for example, T1>T2 is also practical. Preferably, the sum of the thickness T2 of the sealants 120 and the depth D of the fillisters 102 should be greater than the thickness T1 of the OELDs 130 (i.e. T1<T2+D). In light of the foregoing, the fillisters of the transparent cover are filled with the optical fills according to the invention, so as to package the OELDs at the same time. Therefore, the invention is conducive to mass production of the OELDs.

What is claimed is:

1. An organic electro-luminescent device package, comprising:
a substrate;
a plurality of organic electro-luminescent devices disposed on the substrate;
a transparent cover disposed above the substrate to cover the organic electro-luminescent devices, wherein the transparent cover has a plurality of fillisters located above the organic electro-luminescent devices to accommodate the organic electro-luminescent devices, respectively;
a plurality of sealants disposed between the substrate and the transparent cover, each of the sealants surrounding one of the organic electro-luminescent devices, respectively; and
a plurality of optical fills, each of the optical fills respectively filling one of the fillisters and a space surrounded by one corresponding sealant of the plurality of sealants and encapsulating one of the organic electro-luminescent devices.

2. The organic electro-luminescent device package as claimed in claim 1, wherein each of the organic electro-luminescent devices comprises:
a first electrode layer disposed on the substrate;
an organic electro-luminescent layer disposed on the first electrode layer; and
a second electrode layer disposed on the organic electro-luminescent layer.

3. The organic electro-luminescent device package as claimed in claim 2, wherein the first electrode layer is a reflective electrode layer, and the second electrode layer is a transmissive or a semi-transparent electrode layer.

4. The organic electro-luminescent device package as claimed in claim 1, wherein a thickness of each of the organic electro-luminescent devices is T1, a thickness of each of the sealants is T2, a depth of each of the fillisters is D, and T1<T2 or T1<T2+D.

5. A packaging process of organic electro-luminescent devices, comprising:
providing a transparent cover having a plurality of fillisters;
filling each of the fillisters with a liquid optical fill;
forming a plurality of sealants on the transparent cover, each of the sealants surrounding one of the fillisters, respectively;
bonding the transparent cover to the substrate by the sealants, such that the organic electro-luminescent devices are immersed in the liquid optical fills, wherein the substrate has the organic electro-luminescent devices thereon; and
curing the sealants and the liquid optical fills.

6. The packaging process of the organic electro-luminescent devices as claimed in claim 5, wherein each of the fillisters is filled with the liquid optical fill by blade coating, screen printing or nozzle dispensing.

7. The packaging process of the organic electro-luminescent devices as claimed in claim 5, wherein a method of curing the sealants and the liquid optical fills includes ultraviolet curing or thermal curing.
